(19) United States
(12) Patent Application Publication
(10) Pub. No.: US 2022/0120397 A1
(43) Pub. Date: Apr. 21, 2022

(54) LED SURFACE MOUNT INSTALLATION STRUCTURE FOR A DWELLING

(71) Applicant: Efficient LED Install LLC, Fort Gratiot, MI (US)

(72) Inventors: Mark Ward, Fort Gratiot, MI (US); Robert Bennatts, Fort Gratiot, MI (US)

(21) Appl. No.: 17/502,350

(22) Filed: Oct. 15, 2021

Related U.S. Application Data
(60) Provisional application No. 63/092,081, filed on Oct. 15, 2020.

(51) Int. Cl. F21S 8/00; F21V 21/04; F21V 21/088; F21V 19/00

(52) U.S. Cl. CPC F21S 8/036; F21V 21/047; F21Y 2115/10; F21V 19/0005; F21V 21/088

(57) ABSTRACT

A surface mount installation that includes a mounting body having an upper surface separated from a lower surface. The mounting body has an inner opening formed therein receiving an electronic device. The mounting body has brackets attached on the upper surface. Mounting straps are disposed in the brackets. The mounting body is movable along the straps. The straps include a plurality of holes formed therein. The holes receive fasteners therein attaching the straps to studs or joists of a building. At least one wire clip is attached to the mounting body. The at least one wire clip receiving and positioning a wire that is attached to the electronic device.

### CROSS-REFERENCE TO RELATED APPLICATIONS

This application claims priority of U.S. Provisional Application No. 63/092,091 filed Oct. 15, 2020 the contents of which are incorporated herein by reference.

### FIELD OF THE INVENTION

The invention relates to mounting structures to locate and install wires and electronic fixtures.

### BACKGROUND OF THE INVENTION

LED fixtures may be mounted on various surfaces including drywall to supply a desired lighting to a room. Typically, the wiring and electrical components such as a transformer are positioned before drywall is attached to the studs. The drywall installer may position holes in the drywall where the light fixtures are to be positioned or an electrician may need to map locations and fish wires and connect wires through a small hole in the drywall as the transformer and wires are not placed for easy installation. There is therefore a need in the art for a location and installation structure to position the wires and LED fixture components for easy installation.

### SUMMARY OF THE INVENTION

In one aspect, there is disclosed a surface mount installation that includes a mounting body having an upper surface separated from a lower surface. The mounting body has an inner opening formed therein receiving an electronic device. The mounting body has brackets attached on the upper surface. Mounting straps are disposed in the brackets. The mounting body is movable along the straps. The straps include a plurality of holes formed therein. The holes receive fasteners therein attaching the straps to studs or joists of a building.

In another aspect, there is disclosed a surface mount installation that includes a mounting body having an upper surface separated from a lower surface. The mounting body has an inner opening formed therein receiving an electronic device. The mounting body has brackets attached on the upper surface. Mounting straps are disposed in the brackets. The mounting body is movable along the straps. The straps include a plurality of holes formed therein. The holes receive fasteners therein attaching the straps to studs or joists of a building. At least one wire clip is attached to the mounting body. The at least one wire clip receiving and positioning a wire that is attached to the electronic device.

In a further aspect, there is disclosed process of installing an electronic fixture in a building comprising the steps of: providing a building having spaced apart studs or joists; providing a surface mount installation assembly having a mounting body having an upper surface separated from a lower surface, the mounting body having an inner opening formed therein, the mounting body having brackets attached on the upper surface; mounting straps disposed in the brackets, the mounting body movable along the straps, the straps including a plurality of holes formed therein, the surface mount installation assembly including at least one wire clip attached thereon; attaching the surface mount installation assembly to the studs or joists; positioning a wire associated with the electronic device in the at least one wire clip; and attaching drywall to the studs or joists covering the surface mount installation assembly.

### BRIEF DESCRIPTION OF THE DRAWINGS

FIG. 1 is a perspective view of a surface mount installation structure having a circular body;

FIG. 2 is a top view of a surface mount installation structure of FIG. 1 with the straps removed;

FIG. 3 is a side view of a surface mount installation structure of FIG. 1 with the straps removed;

FIG. 4 is a sectional view of a surface mount installation structure taken along the line C-C in FIG. 2;

FIG. 5 is a perspective view of a surface mount installation structure having a square body;

FIG. 6 is a top view of a surface mount installation structure of FIG. 5 with the straps removed;

FIG. 7 is a side view of a surface mount installation structure of FIG. 5 with the straps removed;

FIG. 8 is a sectional view of a surface mount installation structure taken along the line E-E in FIG. 6;

FIG. 9 is a partial perspective view of a strap slot;

FIG. 10 is a partial perspective view of a strap.

FIG. 11 is a perspective view of a surface mount installation structure having a circular body;

FIG. 12 is a perspective view of a surface mount installation structure of FIG. 11 with the straps removed;

FIG. 13 is a perspective view of a locking pin of a surface mount installation structure of FIG. 11;

FIG. 14 is a partial perspective view of a strap of the surface mount installation structure of FIG. 11.

### DETAILED DESCRIPTION OF THE PREFERRED EMBODIMENTS

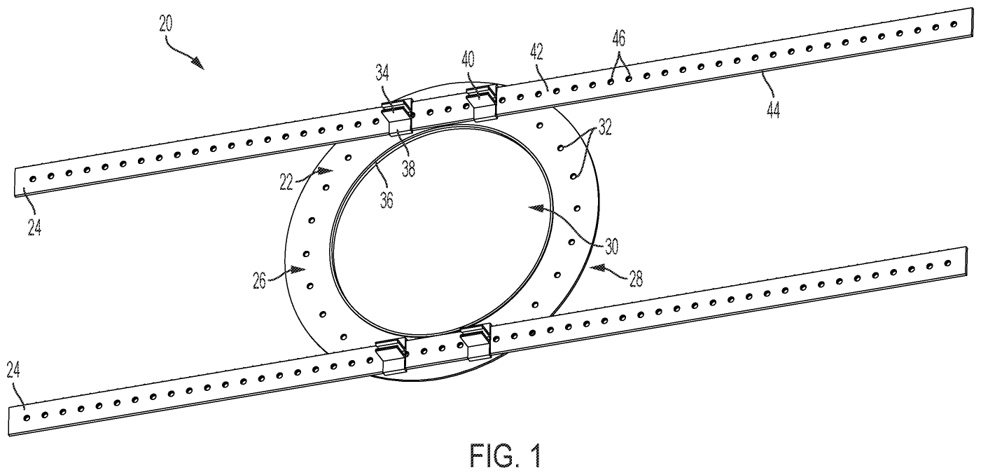

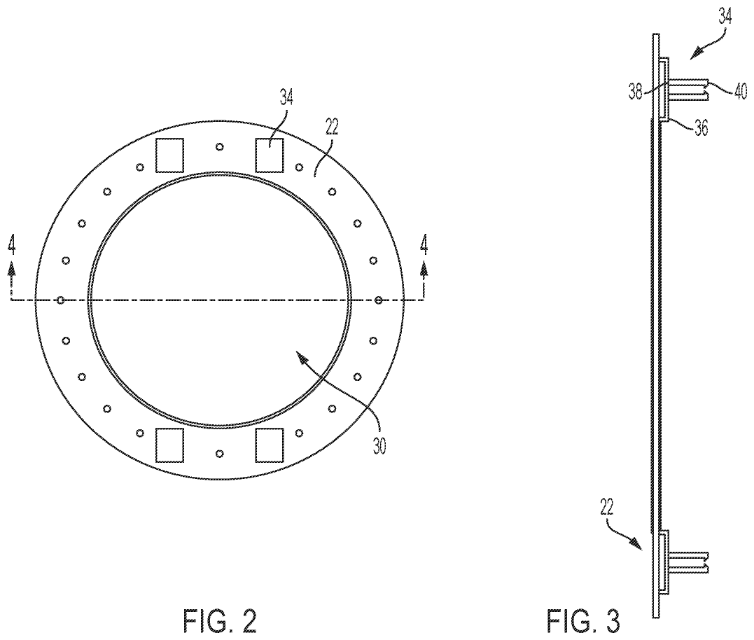

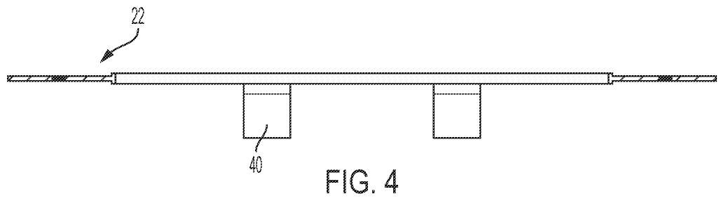

Referring to FIGS. 1-5, there is shown a surface mount installation structure 20 having a mounting body 22 that is circular and mounting straps 24. In one aspect, the circular body 22 and straps 24 may be formed of a thermoplastic material and may be shaped by an injection molding process or an additive manufacturing process.

The circular body 22 includes separated upper and lower surfaces 26, 28. The circular body 22 includes an inner opening 30 formed therein that accommodates an electronic device or an LED lighting fixture (not shown). The circular body 22 may include a plurality of holes 32 formed therein allowing attachment of the circular body 22 in a situation where the mounting straps 24 are not utilized.

The upper surface 26 of the circular body 22 includes brackets 34 attached thereon. The brackets 34 may be attached to the circular body 22 or may be formed monolithically with the circular body 22. The brackets 34 receive the mounting straps 24 and allow sliding movement of the circular body 22 along the straps 24. The brackets 34 include opposing side surfaces 36 coupled by a lateral surface 38.

The surface mount installation structure 20 includes wire attachment clips 40 attached thereon. The wire attachment clips 40 may be attached to the circular body 22 or may be formed monolithically with the circular body 22. In the depicted embodiments, the wire attachment clips 40 are formed on the lateral surface 38 of the brackets 34. Various numbers of wire attachment clips 40 may be utilized.

The straps 24 include opposing mounting surfaces 42 joined by opposing side surfaces 44. The straps 24 include a plurality of holes 46 formed therein for attaching the straps 24 to studs or joists of a building structure. In one aspect, the spacing between adjacent holes 46 is the same spacing as wiring staples commonly utilized by electricians. The spacing is approximately equal to a standard ½ inch romex staple. In one aspect, the straps 24 may be integrally formed with the mounting body 22. In such an embodiment the surface mount installation structure 20 may be a monolithic structure of the straps 24 and mounting body 22.

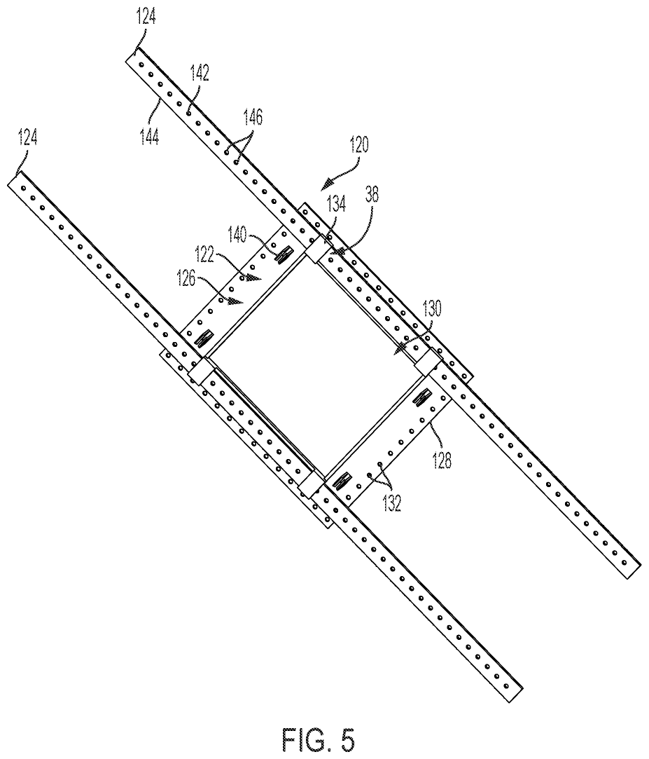

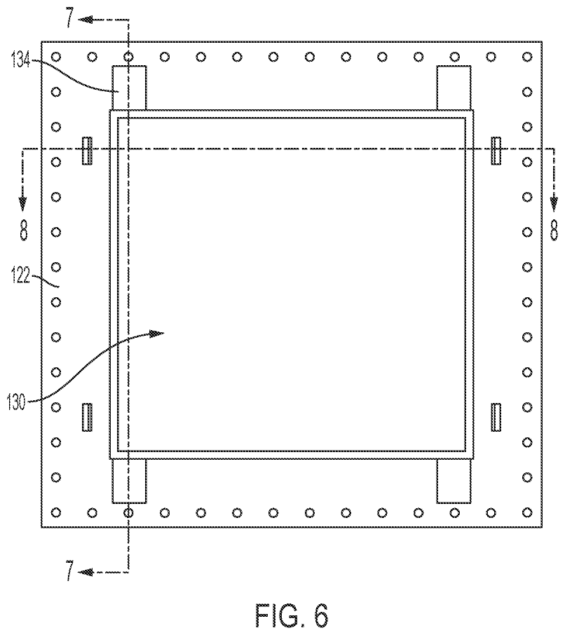

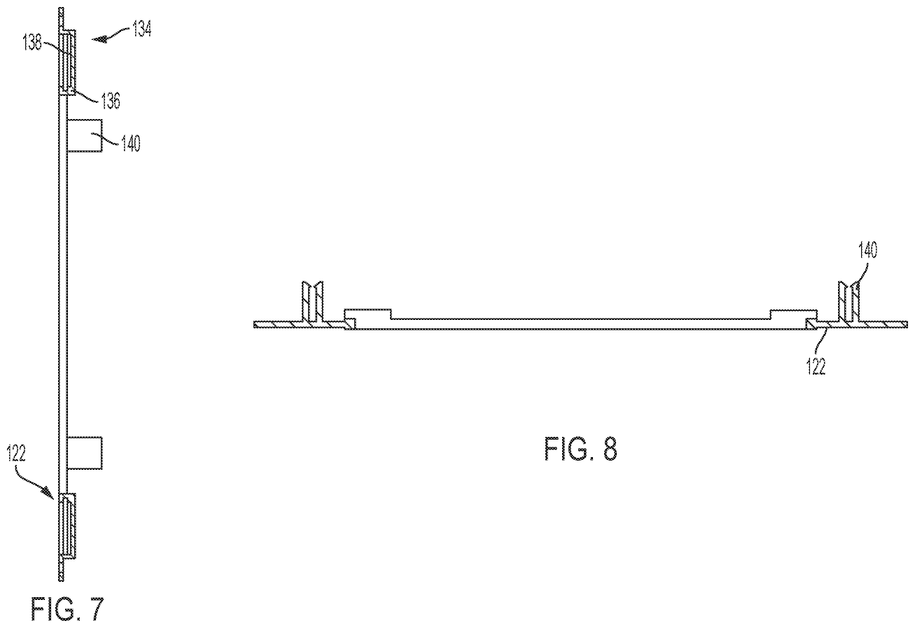

Referring to FIGS. 5-8, there is shown a surface mount installation structure 120 having a square body 122 and mounting straps 124. In one aspect, the square body 122 and straps 124 may be formed of a thermoplastic material and may be shaped by an injection molding process or additive manufacturing process.

The square body 122 includes separated upper and lower surfaces 126, 128. The square body 122 includes an inner opening 130 formed therein that accommodates an LED lighting fixture (not shown). The square body 122 may include a plurality of holes 132 formed therein allowing attachment of the square body 122 in a situation where the mounting straps 124 are not utilized.

The upper surface 126 of the square body 122 includes brackets 134 attached thereon. The brackets 134 may be attached to the square body 122 or may be formed monolithically with the square body 122. The brackets 134 receive the mounting straps 124 and allow sliding movement of the square body 122 along the straps 124. The brackets 134 include opposing side surfaces 136 coupled by a lateral surface 138.

The surface mount installation structure 120 includes at least one wire attachment clips 140 attached thereon. The wire attachment clips 140 may be attached to the square body 122 or may be formed monolithically with the square body 122. Alternatively, the wire attachment clips 140 may be formed on the lateral surface 138 of the brackets 134. Various numbers of wire attachment clips 140 may be utilized.

The straps 124 include opposing mounting surfaces 142 joined by opposing side surfaces 144. The straps 124 include a plurality of holes 146 formed therein for attaching the straps 124 to studs or joists of a building structure. In one aspect, the spacing between adjacent holes 146 is the same spacing as wiring staples commonly utilized by electricians. The spacing is approximately a standard ½ inch romex staple.

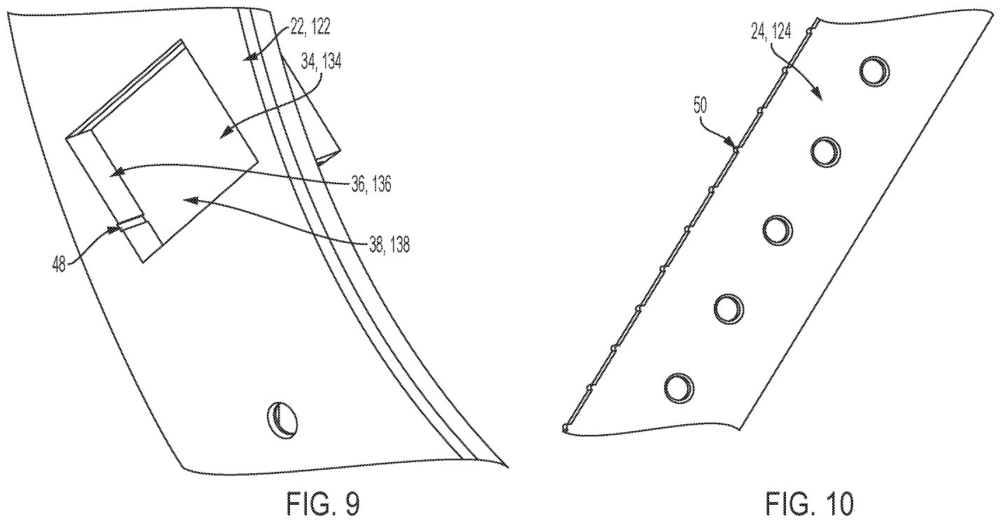

Referring to FIGS. 9 and 10, there is shown the brackets 34, 134 and straps 24, 124 of the embodiments discussed above. In one aspect, at least one of the side surfaces 36, 136 of the brackets 34, 134 includes notches 48 formed thereon. In one aspect, at least one of the side surfaces 44, 144 includes protrusions 50 formed thereon. The protrusions 50 are received in the notches 48 and act as a ratchet allowing movement of the body 22, 122 along the straps at predefined intervals.

In use, the mounting straps 24, 124 are attached to studs or joists of a building structure using fasteners such as staples that are positioned in the holes 46, 146. The body 22, 122 may be slid along the straps 24, 124 to a desired position wherein the protrusions 50 and notches 48 provide a predefined movement along the straps 24, 124. The wiring associated with a LED lighting fixture may be positioned in the wiring attachment clips 40,140 such that the wire is positioned for easy attachment to a lighting fixture without having to fish the wires in a tight space. Additionally, the wire clips 40, 140 locate the wire and prevents the wire from being cut during drywall installation. Drywall may be attached to the joists or studs covering the surface mount installation structure 20, 120. The drywall installer may then cut the drywall about the inner opening 30, 130. Next, an electrician may easily attach the wiring held in the attachment clips 40, 140 to an LED fixture that is positioned in the inner opening 30, 130.

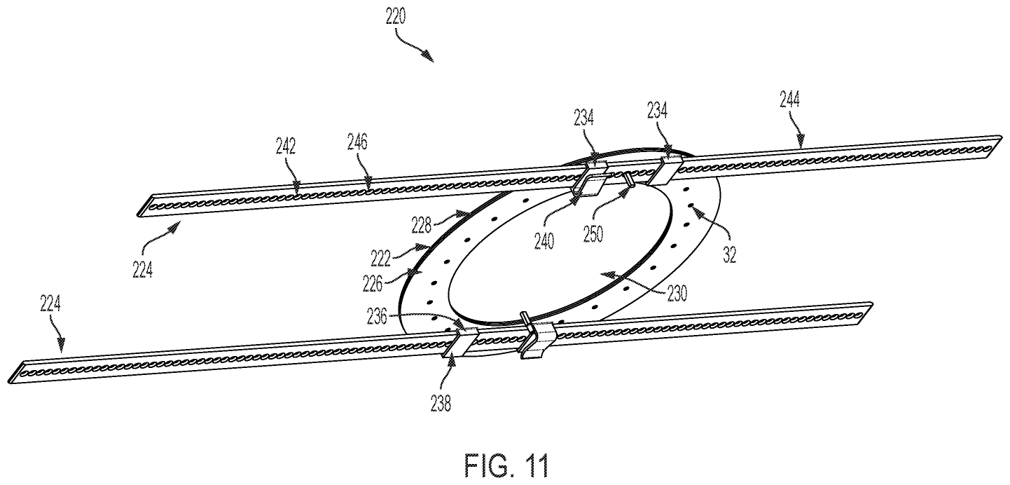

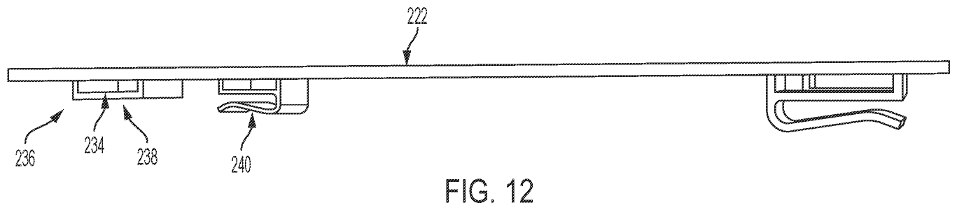

Referring to FIGS. 11-14, there is shown a surface mount installation structure 220 having a circular body 222 and mounting straps 224. In one aspect, the circular body 222 and straps 224 may be formed of a thermoplastic material and may be shaped by an injection molding process or an additive manufacturing process.

The circular body 222 includes separated upper and lower surfaces 226, 228. The circular body 222 includes an inner opening 230 formed therein that accommodates an LED lighting fixture (not shown). The circular body 222 may include a plurality of holes 232 formed therein allowing attachment of the circular body 222 in a situation where the mounting straps 224 are not utilized.

The upper surface 226 of the circular body 222 includes brackets 234 attached thereon. The brackets 234 may be attached to the circular body 222 or may be formed monolithically with the circular body 222. The brackets 234 receive the mounting straps 224 and allow sliding movement of the circular body 222 along the straps 224. The brackets 234 include opposing side surfaces 236 coupled by a lateral surface 238.

The surface mount installation structure 220 includes wire attachment clips 240 attached thereon. The wire attachment clips 240 may be attached to the circular body 222 or may be formed monolithically with the circular body 22. In the depicted embodiments, the wire attachment clips 240 are formed on the lateral surface 238 of the brackets 234. The attachment clips extend laterally relative to the mounting body 222 in the depicted embodiment as opposed to the attachment clips 40 in FIGS. 1-5 which extend vertically relative to the mounting body 22. Various numbers of wire attachment clips 240 may be utilized.

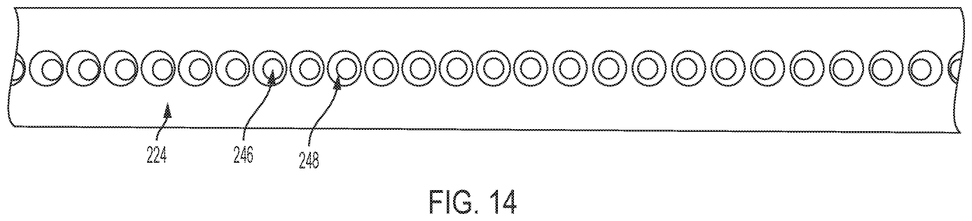

The straps 224 include opposing mounting surfaces 242 joined by opposing side surfaces 244. The straps 224 include a plurality of holes 246 formed therein for attaching the straps 224 to studs or joists of a building structure. In one aspect, the spacing between adjacent holes 46 is the same spacing as wiring staples commonly utilized by electricians. The spacing is approximately equal to a standard ½ inch romex staple. The 246 holes may include a taper 248 best seen in FIG. 14. The taper 248 may engage with a locking pin 250 to prevent movement of the straps 224 within the brackets 234 once a final position of the surface mount installation structure 220 is achieved.

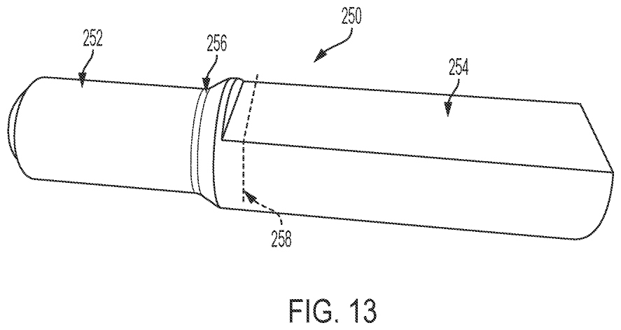

Referring to FIG. 13, the locking pin 250 includes a body having a generally cylindrical portion 252 joined with a rectangular portion 254. The cylindrical portion 252 and rectangular portion 254 are separated by a conical engagement portion 256. The conical engagement portion is inserted into the holes 232 and 246 at a location positioned between the brackets 234. The conical engagement portion 256 locks the strap 224 relative to the body 22, as shown in FIG. 11. In one aspect, the locking pin 250 may include a weakened portion 258 to allow the rectangular portion 254 to be snapped off after the locking pin 250 is installed.

In use, the mounting straps 224 are attached to studs or joists of a building structure using fasteners such as staples that are positioned in the holes 246. The body 222 may be slid along the straps 224 to a desired position. The locking pin 250 may then be inserted into the holes 232 and 246 at a location positioned between the brackets 234. The wiring associated with a LED lighting fixture may be positioned in the wiring attachment clips 240 such that the wire is positioned for easy attachment to a lighting fixture without having to fish the wires in a tight space. Additionally, the wire clips 240 locate the wire and prevents the wire from being cut during drywall installation. Drywall may be attached to the joists or studs covering the surface mount installation structure 220. The drywall installer may then cut the drywall about the inner opening 230. Next, an electrician may easily attach the wiring held in the attachment clips 240 to an LED fixture that is positioned in the inner opening 230.

1. A surface mount installation assembly comprising:
a mounting body having an upper surface separated from a lower surface, the mounting body having an inner opening formed therein receiving an electronic device, the mounting body having brackets attached on the upper surface;
mounting straps disposed in the brackets, the mounting body movable along the straps, the straps including a plurality of holes formed therein, the holes receiving fasteners therein attaching the straps to studs or joists of a building.

2. The surface mount installation assembly of claim 1 including at least one wire clip attached thereon, the at least one wire clip receiving and positioning a wire that is attached to the electronic device.

3. The surface mount installation assembly of claim 1 wherein the mounting body includes a plurality of holes formed therein allowing attachment of the mounting body to studs or joists of a building.

4. The surface mount installation assembly of claim 1 wherein the wire attachment clips are formed on a lateral surface of the brackets.

5. The surface mount installation assembly of claim 1 wherein a spacing between adjacent holes of the mounting straps is equal to a spacing of a half inch wiring staple.

6. The surface mount installation assembly of claim 3 wherein a spacing between adjacent holes of the mounting body is equal to a spacing of a half inch wiring staple.

7. The surface mount installation assembly of claim 1 wherein the mounting body has a circular shape.

8. The surface mount installation assembly of claim 1 wherein the mounting body has a square or rectangular shape.

9. The surface mount installation assembly of claim 2 wherein the wire clip extends laterally relative to the mounting body.

10. The surface mount installation assembly of claim 2 wherein the wire clip extends vertically relative to the mounting body.

11. The surface mount installation assembly of claim 1 wherein the straps include a side surface with protrusions formed thereon, the protrusions received in notches formed in bracket defining a ratchet.

12. The surface mount installation assembly of claim 1 wherein the plurality of holes formed in the strap include a taper formed thereon.

13. The surface mount installation assembly of claim 1 including a locking pin positioned in a last one hole of the plurality of holes formed in the mounting body and positioned in at least one hole of the plurality of holes formed in strap locking the mounting strap relative to the mounting body.

14. The surface mount installation assembly of claim 13 wherein the locking pin includes a breakaway line formed thereon.

15. A process of installing an electronic fixture in a building comprising the steps of:
providing a building having spaced apart studs or joists;
providing a surface mount installation assembly having a mounting body having an upper surface separated from a lower surface, the mounting body having an inner opening formed therein, the mounting body having brackets attached on the upper surface; mounting straps disposed in the brackets, the mounting body movable along the straps, the straps including a plurality of holes formed therein, the surface mount installation assembly including at least one wire clip attached thereon;
attaching the surface mount installation assembly to the studs or joists;
positioning a wire associated with the electronic device in the at least one wire clip;
attaching drywall to the studs or joists covering the surface mount installation assembly.

16. The process of installing an electronic fixture in a building of claim 15 including the step of cutting drywall from the inner opening of the mounting body.

17. The process of installing an electronic fixture in a building of claim 16 including the step of retrieving the wire from the wire clip and attaching the wire to an electronic device positioned in the inner opening.

18. The process of installing an electronic fixture in a building of claim 15 including the step of adjusting a position of the mounting body along the straps.

19. The process of installing an electronic fixture in a building of claim 18 including the step of locking a position of the mounting body relative to the straps.

20. A surface mount installation assembly comprising:
a mounting body having an upper surface separated from a lower surface, the mounting body having an inner opening formed therein receiving an electronic device, the mounting body having brackets attached on the upper surface;
mounting straps disposed in the brackets, the mounting body movable along the straps, the straps including a plurality of holes formed therein, the holes receiving fasteners therein attaching the straps to studs or joists of a building;
at least one wire clip attached to the mounting body, the at least one wire clip receiving and positioning a wire that is attached to the electronic device.
